(19) United States
(12) Patent Application Publication
(10) Pub. No.: US 2011/0002554 A1
(43) Pub. Date: Jan. 6, 2011

(54) DIGITAL IMAGE COMPRESSION BY RESIDUAL DECIMATION

(75) Inventors: Serhan Uslubas, Dallas, TX (US); Aggelos K. Katsaggelos, Chicago, IL (US); Faisal Ishtiaq, Chicago, IL (US); Shih-Ta Hsiang, Schaumburg, IL (US); Ehsan Maani, San Jose, CA (US)

Correspondence Address: MOTOROLA, INC.;Penny Tomko, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/795,200

(22) Filed: Jun. 7, 2010

Related U.S. Application Data
(60) Provisional application No. 61/186,228, filed on Jun. 11, 2009.
(60) Provisional application No. 61/186,236, filed on Jun. 11, 2009.

(51) Int. Cl. G06K 9/46

(52) U.S. Cl. 382/238

(57) ABSTRACT

Disclosed is an image encoder that divides a digital image into a set of “macroblocks.” Each macroblock is encoded by applying spatial (and possibly temporal) prediction. The “residual” of the macroblock is calculated as the difference between the predicted content of the macroblock and the actual content of the macroblock. The residual is then “decimated” by taking an orderly subset of its values. The decimated residual is then either transmitted to an image decoder or is stored for later use. To recreate the original image, the macroblocks are first recreated from their received residuals. When a decimated residual is received, the values of the residual left out during decimation are interpolated from the values actually received. Using the prediction techniques along with the residual, the original content of the macroblock is recovered. The macroblocks are then joined to form the original digital image.

### CROSS-REFERENCE TO RELATED APPLICATIONS

This application claims priority to U.S. Provisional Patent Applications 61/186,228 and 61/186,236, both filed on Jun. 11, 2009. This application is related to a U.S. Utility Patent Application with attorney docket number CML07337.

### FIELD OF THE INVENTION

The present invention is related generally to digital imaging and, more particularly, to compressing digital images.

### BACKGROUND OF THE INVENTION

As the availability of high definition (HD) video continues to increase, it will dominate the video market in the upcoming decades. Such an extensive use of HD video requires a significant amount of bandwidth for storage and transmission. For example, an HD spatial resolution of 1920×1080 progressive scan (1080p) results in approximately three Gigabits of uncompressed data per second of content. This enormous data rate gives rise to unprecedented visual quality which is well suited for liquid-crystal displays and plasma displays. On the other hand, high data rates place a burden on the transmission and storage of high definition video. For a typical example, a standard DVD-5 can only hold about twelve seconds of such content. This example highlights the need for exceptional compression systems for dealing with HD video. The current state-of-the-art video coding standard H.264/JVT/AVC/MPEG-4 provides substantial compression efficiency compared to earlier video coding standards. However, it is still desirable to exceed what is provided by this standard.

### BRIEF SUMMARY

The above considerations, and others, are addressed by the present invention, which can be understood by referring to the specification, drawings, and claims. According to aspects of the present invention, an image encoder divides a digital image into a set of “macroblocks.” Each macroblock is then encoded by applying spatial (and possibly temporal) prediction. The “residual” of the macroblock is calculated as the difference between the predicted content of the macroblock and the actual content of the macroblock. The residual is then “decimated” by taking an orderly subset of its values. (That is, the residual is “downsampled.”) The decimated residual is then either transmitted to an image decoder or stored for later use. (Note that in some situations, some but not all macroblocks are passed through the decimation process.)

Some embodiments may decide to send more than the original decimated residual. “Refinement sub-residuals” are calculated. One or more of the refinement sub-residuals is sent along with the decimated residual if doing so would minimize a rate-distortion (RD) cost function.

To recreate the original image, the macroblocks are first recreated from their received residuals. When a decimated residual is received, the values of the residual left out during decimation are interpolated from the values actually received (and possibly from any refinement sub-residuals received). (That is, the decimated residual is “upsampled.”) Using the prediction techniques along with the residual, the original content of the macroblock is recovered. The macroblocks are then joined to form the original digital image.

The decimation technique saves on transmission or storage costs whenever a decimated, rather than a full, residual is sent. Decimation may decrease the resolution of the macroblock, so, in some embodiments, decimation is only performed where any loss of resolution in the macroblock would be insignificant, that is, where the original macroblock contains only low-frequency information.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram illustrating spatial and temporal sampling of images;

FIG. 2 is a schematic of a representative prior-art image encoder;

FIG. 3 is a schematic of a representative prior-art image decoder;

FIG. 4 is a block diagram illustrating a number of 4×4 intra prediction modes;

FIG. 5 is a block diagram illustrating a number of 16×16 intra prediction modes;

FIG. 6 is a block diagram illustrating motion-compensated prediction;

FIG. 7 is a block diagram illustrating a number of inter prediction partitioning modes;

FIG. 8 is a schematic of an image encoder according to one embodiment of the present invention;

FIG. 9 is a schematic of an image decoder according to one embodiment of the present invention;

FIGS. 10a and 10b together form a flowchart of a method for compressing a digital image, according to one embodiment of the present invention;

FIGS. 11a and 11b together form a flowchart of a method for decompressing a digital image, according to one embodiment of the present invention;

FIG. 12 is a chart comparing compression results produced by one embodiment of the present invention with a previous technique;

FIG. 13 is a schematic of an image encoder according to one embodiment of the present invention;

FIG. 14 is a schematic of an image decoder according to one embodiment of the present invention;

FIGS. 15a and 15b together form a flowchart of a method for compressing a digital image, according to one embodiment of the present invention;

FIG. 16 is a block diagram illustrating residual reorganization;

FIGS. 17a and 17b are block diagrams illustrating hierarchical residual reorganization;

FIGS. 18a and 18b together form a flowchart of a method for decompressing a digital image, according to one embodiment of the present invention;

FIG. 19 is a block diagram illustrating residual interpolation; and

FIG. 20 is a chart comparing compression results produced by one embodiment of the present invention with a previous technique.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

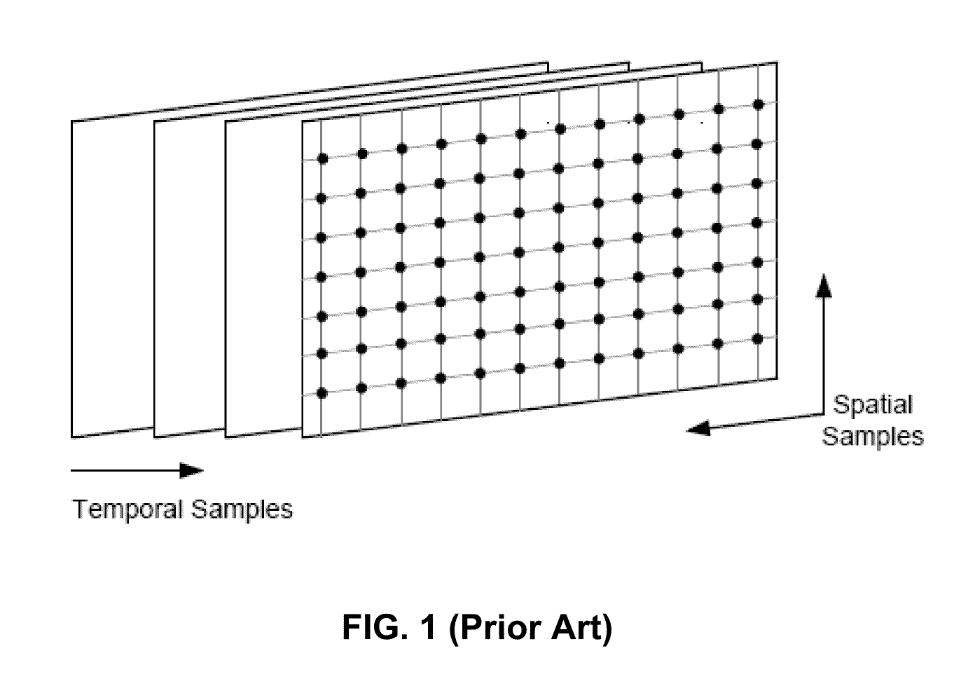

The present discussion begins with a very brief overview of some terms and techniques known in the art of digital image compression. This overview, accompanied by FIGS. 1 through 7, is not meant to teach the known art in any detail. Those skilled in the art know how to find greater details in textbooks and in the relevant standards.

A real-life visual scene is composed of multiple objects laid out in a three-dimensional space that varies temporally. Object characteristics such as color, texture, illumination, and position change in a continuous manner. Digital video is a spatially and temporally sampled representation of the real-life scene. It is acquired by capturing a two-dimensional projection of the scene onto a sensor at periodic time intervals. Spatial sampling occurs by taking the points which coincide with a sampling grid that is superimposed upon the sensor output. Each point, called pixel or sample, represents the features of the corresponding sensor location by a set of values from a color space domain that describes the luminance and the color. A two-dimensional array of pixels at a given time index is called a frame. FIG. 1 illustrates spatio-temporal sampling of a visual scene.

Video encoding systems achieve compression by removing redundancy in the video data, i.e., by removing those elements that can be discarded without adversely affecting reproduction fidelity. Because video signals take place in time and space, most video encoding systems exploit both temporal and spatial redundancy present in these signals. Typically, there is high temporal correlation between successive frames. This is also true in the spatial domain for pixels which are close to each other. Thus, high compression gains are achieved by carefully exploiting these spatio-temporal correlations.

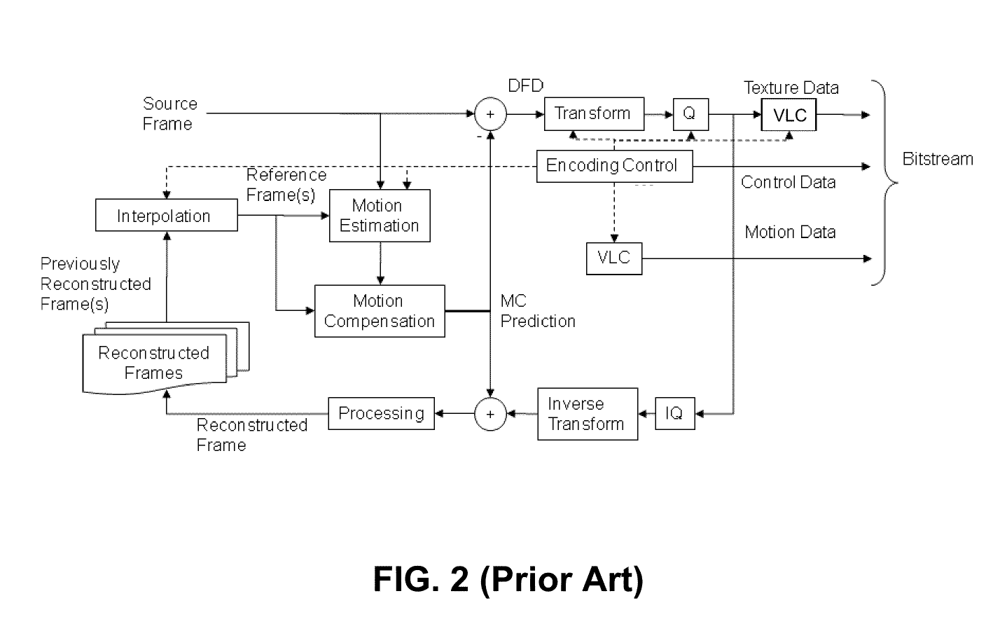

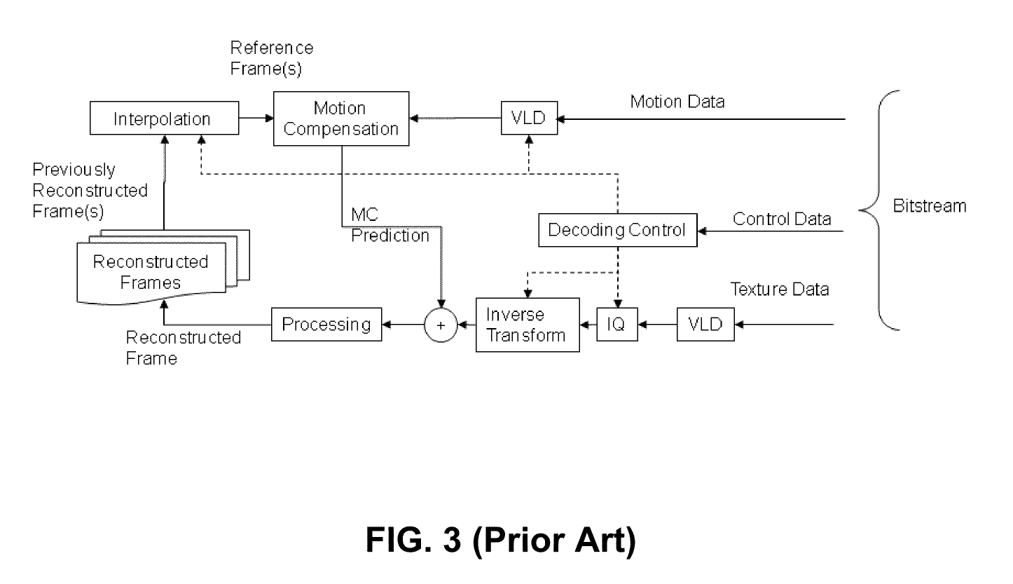

Consider one of the most widely adopted video coding schemes, namely block-based hybrid video coding. The major video coding standards, such as H.261, H.263, MPEG-2, MPEG-4 Visual, and the current state-of-the-art H.264/AVC are based on this model. A block-based coding approach divides a frame into elemental units called macroblocks. For source material in 4:2:0 YUV format, one macroblock encloses a 16×16 region of the original frame, which contains 256 luminance, 64 blue chrominance, and 64 red chrominance samples. Encoding a macroblock involves a hybrid of three techniques: prediction, transformation, and entropy coding. All luma and chroma samples of a macroblock are predicted spatially or temporally. The difference between the prediction and the original is put through transformation and quantization processes, whose output is encoded using entropy-coding methods. FIG. 2 shows an H.264/AVC video encoder built on a block-based hybrid video coding architecture. FIG. 3 shows a corresponding H.264/AVC video decoder.

Prediction exploits the spatial or temporal redundancy in a video sequence by modeling the correlation between sample blocks of various dimensions, such that only a small difference between the actual and the predicted signal needs to be encoded. A prediction for the current block is created from the samples which have already been encoded. In H.264/AVC, there are two types of prediction: intra and inter.

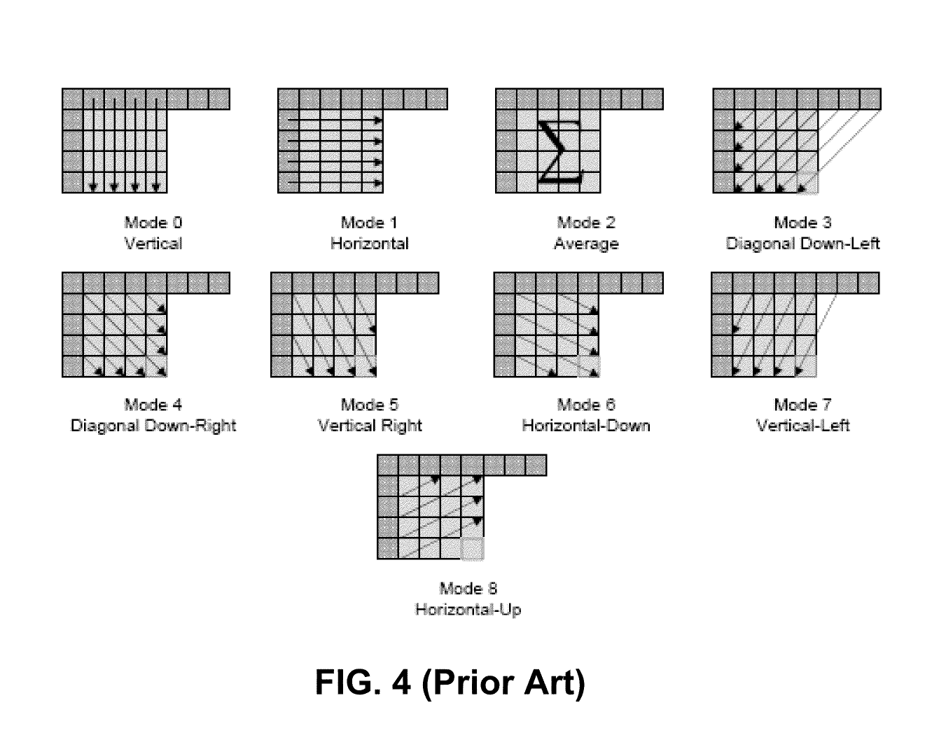

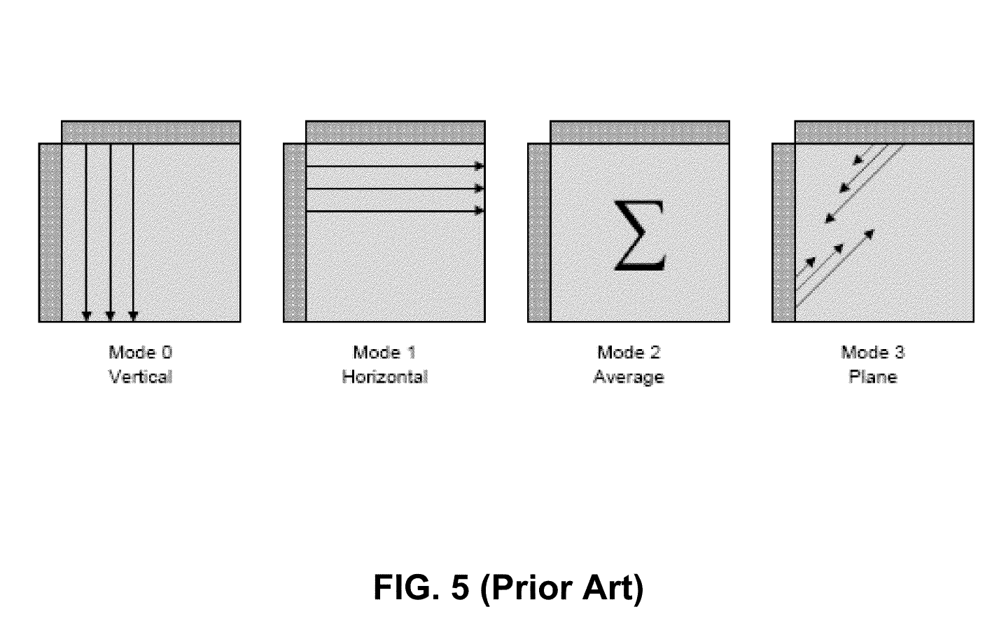

Intra Prediction: A high level of spatial correlation is present between neighboring blocks in a frame. Consequently, a block can be predicted from the nearby encoded and reconstructed blocks, giving rise to the intra prediction. In H.264/AVC, there are nine intra prediction modes for each 4×4 luma block of a macroblock and four 16×16 prediction modes for predicting the whole macroblock. FIGS. 4 and 5 illustrate the prediction directions for the 4×4 and the 16×16 intra prediction modes, respectively. The prediction can be formed by a weighted average of the previously encoded samples, located above and to the left of the current block. The encoder selects the mode that minimizes the difference between the original and the prediction and signals this selection in the control data. A macroblock that is encoded in this fashion is called I-MB.

Inter Prediction: Video sequences have high temporal correlation between frames, enabling a block in the current frame to be accurately described by a region in the previous frames, which are known as reference frames. Inter prediction utilizes previously encoded and reconstructed reference frames to develop a prediction using a block-based motion estimation and compensation technique.

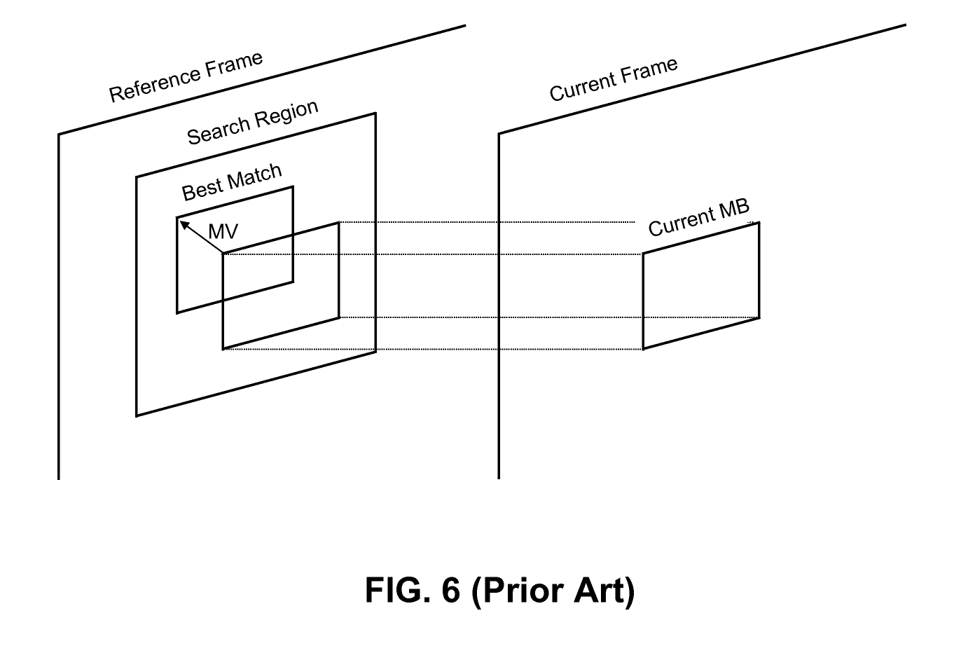

Most video coding systems employ a block-based scheme to estimate the motion displacement of an M×N rectangular block. In this scheme, the current M×N block is compared to candidate blocks in the search area of the reference frames. Each candidate block represents a prediction for the current block. A cost function is calculated to measure the similarity of the prediction to the actual block. Some popular cost functions for this method are sum of the absolute differences (SAD) and sum of the squared errors (SSE). The candidate with the lowest cost function is selected as the prediction for the current block. A residual is acquired by subtracting the current block from the prediction. The residual is subsequently transformed, quantized, and encoded. The displacement offset, or the motion vector, is also signalled in the encoded bitstream. The decoder receives the motion vector, determines the prediction region, and combines it with the decoded residual to reconstruct the encoded block. This process is called motion-compensated prediction and is illustrated in FIG. 6.

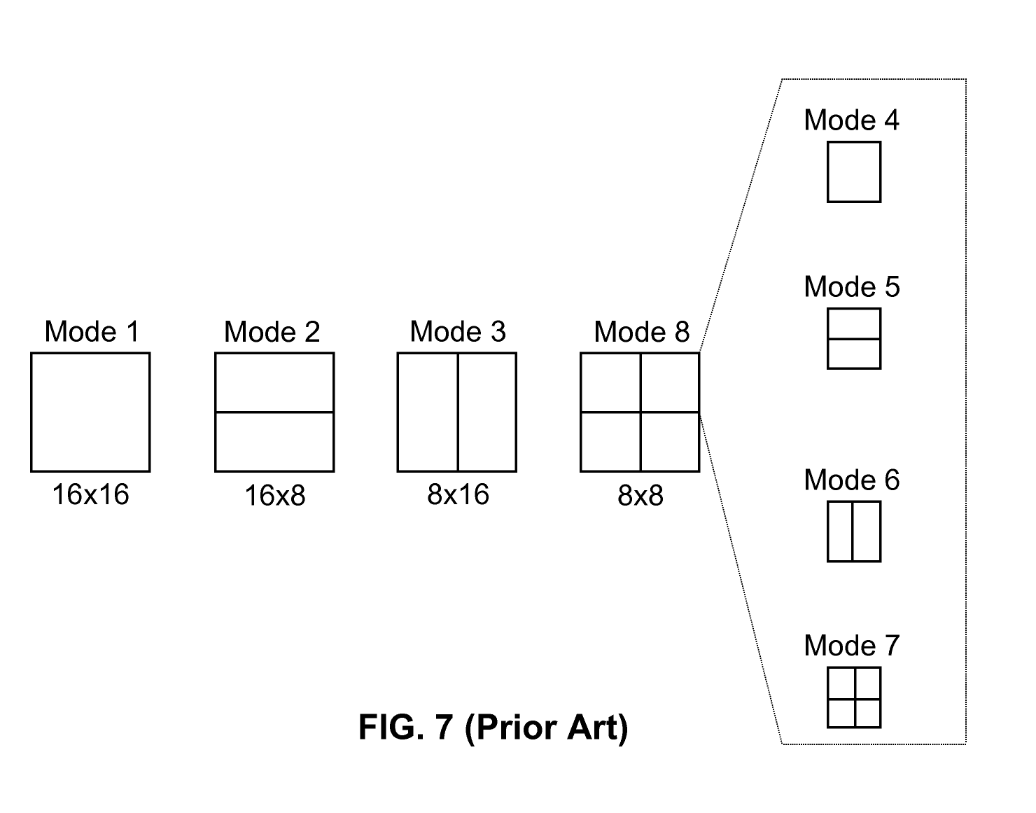

H.264/AVC uses more sophisticated methods for inter prediction. A 16×16 macroblock can be divided into partitions of size 16×16, 16×8, 8×16, or 8×8, where each block can be motion-compensated independently. If an 8×8 partitioning is selected, then the encoder can further choose to partition each 8×8 block into sub-partitions of size 8×8, 8×4, 4×8, or 4×4. Each partition is encoded independently with a motion vector and a residual of its own. The use of variable block sizes helps to obtain better motion prediction for highly textured macroblocks and increases coding efficiency by reducing the residual energy left to be encoded. FIG. 7 shows the partitioning modes used in H.264/AVC.

Another important factor affecting inter prediction accuracy is motion-vector precision. In H.264/AVC, precision of the motion vectors is one quarter of the distance between luma samples. If the motion vector happens to point to a non-integer position in the reference picture, then the value at that position is calculated using interpolation. Prediction samples at half-sample positions are obtained by filtering the original reference frame horizontally and vertically with a 6-tap filter. Sample values at quarter sample positions are derived bilinearly by averaging with upward rounding of the two nearest samples at integer and half-sample positions. Use of quarter-pel motion vector precision is one of the major improvements of H.264/AVC over its predecessors.

H.264/AVC also allows motion compensation using multiple reference frames. A prediction can be formed as a weighted sum of blocks from several frames. Furthermore, H.264/AVC supports use of future pictures as reference frames by decoupling display and coding order. This type of prediction is known as bi-predictive motion compensation. A macroblock that utilizes bi-predictive motion compensation is called B-MB. On the other hand, if only the past frames are used for prediction, the macroblock is referred to as P-MB.

The difference between the prediction and the original macroblock, the residual, is encoded for a high fidelity reproduction of the decoded sequence. H.264/AVC utilizes a block-based transformation and quantization technique to achieve this. A separable integer transform with similar properties to a Discrete Cosine Transform (DCT) is applied to each 4×4 block of the residual. The transformation localizes and concentrates the sparse spatial information. This allows efficient representation of the information and enables frequency-selective quantization. Previous video coding standards used 8×8 DCT transforms, which were computationally expensive and prone to drift problems due to floating-point implementation. H.264/AVC relies heavily on intra and inter prediction, which makes it very sensitive to encoder-decoder mismatches and drift accumulation. In order to overcome these shortcomings, H.264/AVC uses a 4×4 integer transform and its inverse complement, which can be computed exactly in integer arithmetic using only additions and shifts. Also, the smaller transformation block size leads to higher compression efficiency and reduction of reconstruction ringing artifacts.

In an H.264/AVC encoder, a 4×4 residual is transformed by a 4×4 integer transformation kernel. The entries of the result are scaled element-wise for DCT approximation and quantized for lossy compression.

Quantization reduces the range of values a signal can take, so that it is possible to represent the signal with fewer bits. In video encoding, quantization is the step that introduces loss, so that a balance between bitrate and reconstruction quality can be established. H.264/AVC employs a scalar quantizer whose step size is controlled by a quantization parameter.

H.264/AVC codecs combine transform scaling and quantization into a single step. A 4×4 input residual X is transformed into unscaled coefficients Y. Subsequently, each element of Y is scaled and quantized. Scaled and quantized coefficients of the 4×4 block are then reorganized into a 16×1 array in zig-zag order and sent to the entropy coder. At the decoder side, the process is reversed for rescaling and inverse transformation. A received coefficients block is pre-scaled with element-wise multiplication and inverse transformed to obtain the residual.

The entropy coder takes the syntax elements, such as the mode information and the quantized coefficients, and represents them efficiently in the bitstream. H.264/AVC employs two different encoders in order to achieve this: context-adaptive variable-length coding (CAVLC) and context-adaptive binary-arithmetic coding (CABAC).

Variable-length coding assigns short codewords to elements which appear with a high frequency in the system. H.264/AVC uses two different coding schemes in order to achieve coding efficiency and target decoder complexity. A simple exponential-Golomb table is employed for coding syntax elements. Exponential-Golomb codes can be extended infinitely in order to accommodate more codewords. On the other hand, quantized coefficients are encoded with the more efficient CAVLC. In this method, VLC tables are switched depending on the local statistics of the transmitted bitstream. Each VLC table is optimized to match different statistical bitstream characteristics. Using the VLC table that is better suited for the local bitstream increases the coding efficiency with respect to single-table VLC schemes.

Quantized transform coefficients, vector extracted using zig-zag scanning, yield large magnitude coefficients towards the beginning of the array, followed by sequences of ±1s, called trailing ones, and many zeros. CAVLC exploits these patterns by coding the number of nonzero coefficients, trailing ones, and coefficient magnitudes separately. Such a scheme allows for more compact and optimized design of VLC tables, contributing to the superior coding efficiency of H.264/AVC.

The quality of the reconstructed image sequence is determined to evaluate the performance of a video codec. Peak signal-to-noise ratio (PSNR) is an objective quality metric based on a logarithmic scale. It depends on the mean squared error between the original and the reconstructed frame. PSNR can be calculated easily and quickly, which makes it a very popular metric among video compression systems.

According to a first embodiment of the present invention (herein called “RAMB” for Resolution-Adaptive Macroblock coding), macroblocks that contain smoothly varying intensity values can be predicted in a lower-resolution grid by first low-pass filtering and then downsampling the input macroblock. (Here, “downsampling” or “decimating” means representing an original signal with fewer spatial samples. This is achieved by discarding some of the pixels of the original image based on a new sampling grid. Downsampling corresponds to a resolution reduction in the original image.) Because there are fewer residual values to encode in the lower-resolution representation (only 25% of the original resolution residual samples in a downsampling-by-two scenario), a substantial compression efficiency is achieved. In order to decode and display the macroblock in the original resolution, it is “upsampled” by interpolation. (Upsampling, the reverse of downsampling, means representing a low-resolution image in a high-resolution grid by calculating the missing samples through interpolation.) When the original macroblock contains mostly low-frequency content, the distortion introduced by the resampling process is kept minimal. Overall, the benefits of the better compression efficiency exceed the slight quality decrease. These benefits are realized by monitoring the RD costs of both the original and the low-resolution modes and only downsampling the macroblocks whose low-resolution mode RD cost is better than that of the conventional encoding.

Appropriate downsampling of the flat and smooth parts of the image prior to compression helps to reduce the bit cost of the encoded stream without sacrificing quality for still images. An RAMB codec can encode a part of an image in lower resolution with fewer bits. At the opposite side of this compression system, a decoder reconstructs this region in the original resolution through a combination of interpolation and residual coding.

Regions to be downsampled are analyzed adaptively in units of macroblock. This enables the encoder to decide whether to downsample the current macroblock or to keep it in the original resolution by monitoring the associated RD costs thus making the optimal coding decision for each macroblock.

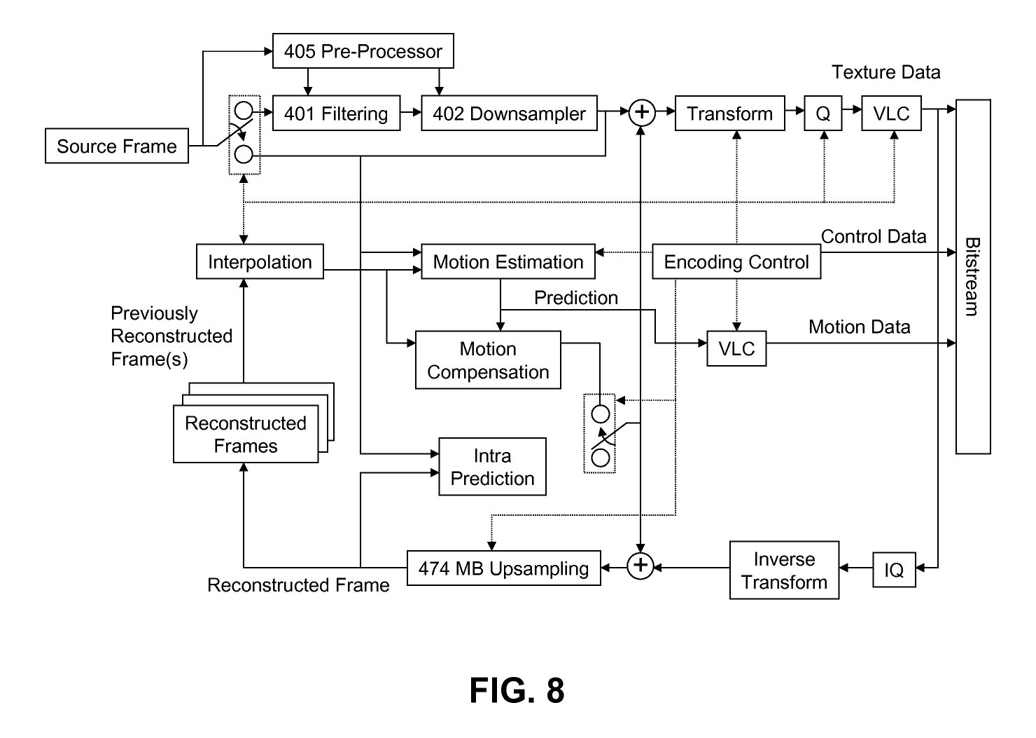

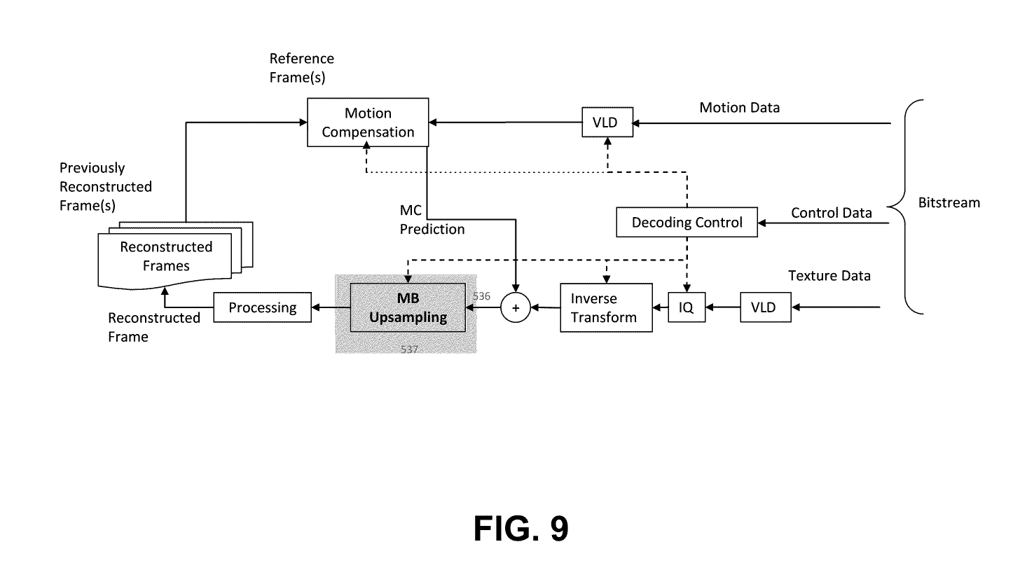

FIG. 8 shows how RAMB-specific processing elements (items 401, 402, 405, and 474) can be added to an existing encoder framework. (Compare FIG. 8 with the prior-art encoder of FIG. 2). Similarly, FIG. 9 shows the incorporation of RAMB-specific elements (536, 537) into an existing decoder. (Compare FIG. 9 with the prior-art decoder of FIG. 3).

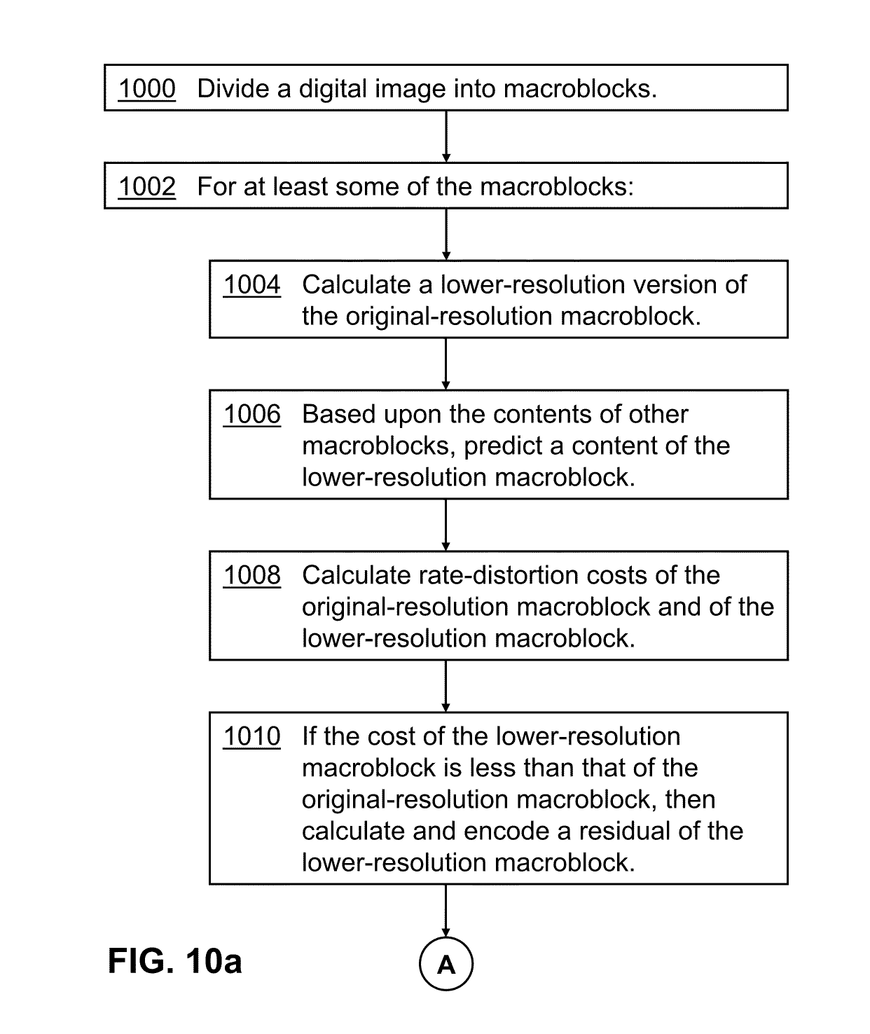

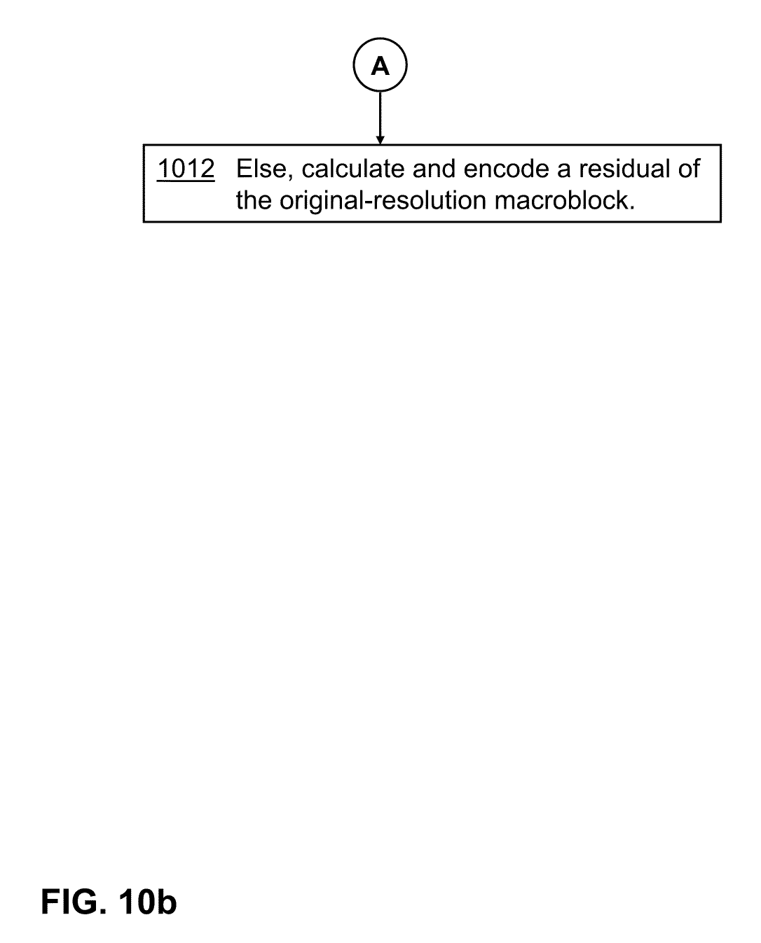

The flowchart of FIGS. 10a and 10b presents one embodiment of an RAMB encoder. The digital image is divided into macroblocks as known in the art (step 1000). As discussed above, each macroblock is either intra or inter.

Each intra macroblock S is downsampled prior to intra prediction according to the following equation:

S^{LR}=F_{D}(S_{org}) (1)

where F() is a general filtering and downsampling operator and S_{org} is the input macroblock (step 1004).

Then, for each macroblock S^{LR} the best low-resolution intra prediction mode m^{LR*} is selected according to the Lagrangian cost function:

m^{LR*}=arg minD_{IP}^{LR}(Sₘ^{LR},m)+λ_{IP}R_{IP}(m) (2)

for all m where λ_{IP} is the given Lagrangian parameter, Sₘ^{LR} is the intra-prediction of the macroblock, R_{IP}^{(m)} is the number of bits required to encode this mode, and D_{IP}(S^{LR}, m) is the intra predicted distortion of the low-resolution block for mode m, which is computed by:

$${D}_{IP}^{LR} ( {S}^{LR} , m ) = {\sum }_{j , i ∈ LR} {\vert {S}_{m}^{LR} ( j , i ) - {S}^{LR} ( j , i ) \vert}^{2} . \qquad ( 3 )$$

Subsequently, the RD cost of encoding the macroblock in low resolution with the mode m^{LR*} is computed (step 1008) and compared with the RD cost of regular H.264 intra coding (step 1008). The low-resolution RD cost C^{LR} is defined as:

C^{LR}=D^{LR}+λ_{IP}R_{IP}(m^{LR*}) (4)

where D^{LR} is the distortion of the low-resolution coding after upsampling of the reconstructed macroblock as given by:

D^{LR}=D{U(T⁻¹[Q⁻¹[Q[T[S^{LR}−Sₘ_{^{LR*}}^{LR}]]]])+S_{org}} (5)

where D{} is the distortion function, U() is a general interpolation operator, and Q and T are quantization and transformation operators, respectively. The RD cost of conventional coding C^{HR} is also calculated as defined by the H.264/AVC standard. In step 1010, if C^{LR} is less than C^{HR}, then the macroblock is encoded with RAMB, otherwise conventional coding is used (step 1012).

For each inter macroblock, RAMB downsamples the original macroblock prior to motion estimation. Therefore, similar to the intra-coding mode, the pixel values in the low-resolution macroblock are mapped to the high-resolution macroblock according to:

S^{LR}=F_{D}(S_{org}). (6)

Given the Lagrange parameter λₚ and the decoded low-resolution reference picture I_{REF}^{LR}, the rate-constrained motion estimation for low resolution is acquired by minimizing the Lagrangian cost function:

v^{LR*}=arg minDFD(Sᵥ_{^{LR}}^{LR},v^{LR},I_{REF}^{LR})+λ_{P}R_{P}^{LR}(S^{LR},v^{LR}) (7)

for v^{LR} εV where v^{LR} and R_{P} denote the motion vector and the inter prediction rate in the low resolution, respectively. Displaced frame difference is defined by:

$$DFD ( {S}_{{v}^{LR}}^{LR} , {v}^{LR} , {I}_{REF}^{LR} ) = {\sum }_{j , i ∈ LR} {\vert {S}^{LR} ( j , i ) - {I}_{REF}^{LR} ( j + {v}_{y} , i + {v}_{x} ) \vert}^{k} \qquad ( 8 )$$

with k=1 for the SAD and k=2 for the SSD. Following motion estimation, an RD cost C_{P}^{LR} for low-resolution inter coding is calculated by:

C_{P}^{LR}=D_{P}^{LR}+λ_{P}R_{P}^{LR}(Sᵥ_{^{LR}}^{LR},v^{LR*}) (9)

where D^{LR} is the distortion of the low-resolution coding after upsampling of the reconstructed macroblock, as given by:

D_{P}^{LR}=D{U(T⁻¹[Q⁻¹[Q[T[S^{SR}−Sᵥ_{^{LR*}}]]]])+S_{org}} (10)

where D{} is the distortion function, U{} is a general interpolation operator, and Q and T are quantization and transformation operators, respectively. The RD cost of conventional coding C^{HR} is also calculated as defined by H.264/AVC standard. In step 1010, if C^{LR} is less than C^{HR}, then the inter macroblock is encoded with the proposed scheme, otherwise conventional coding is used (step 1012).

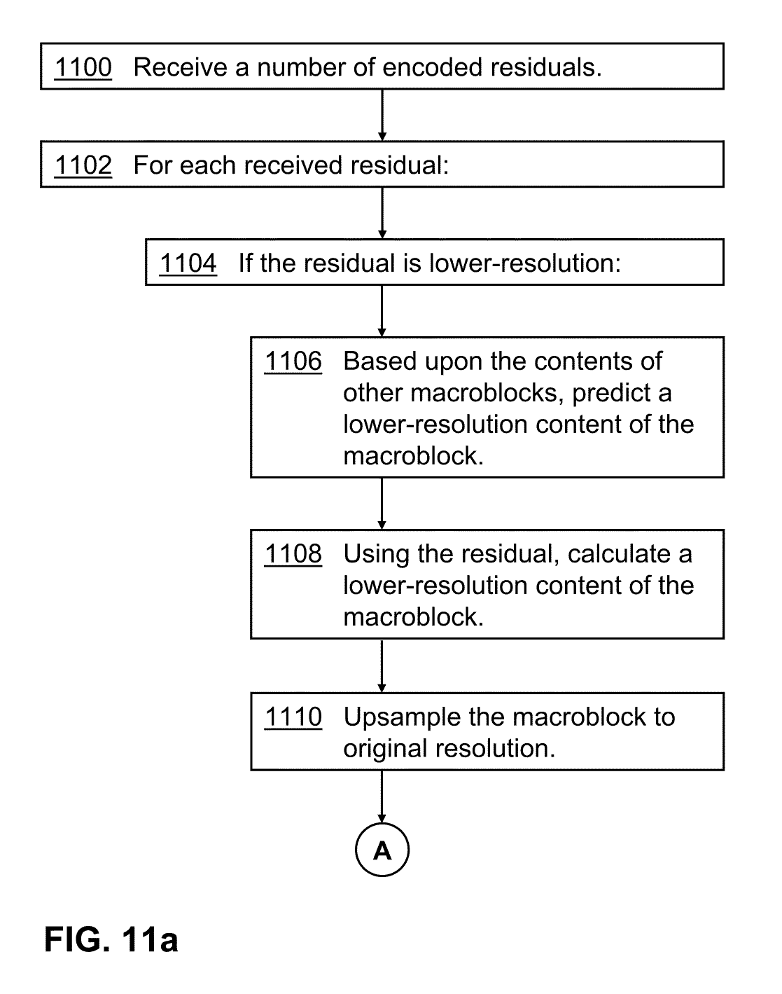

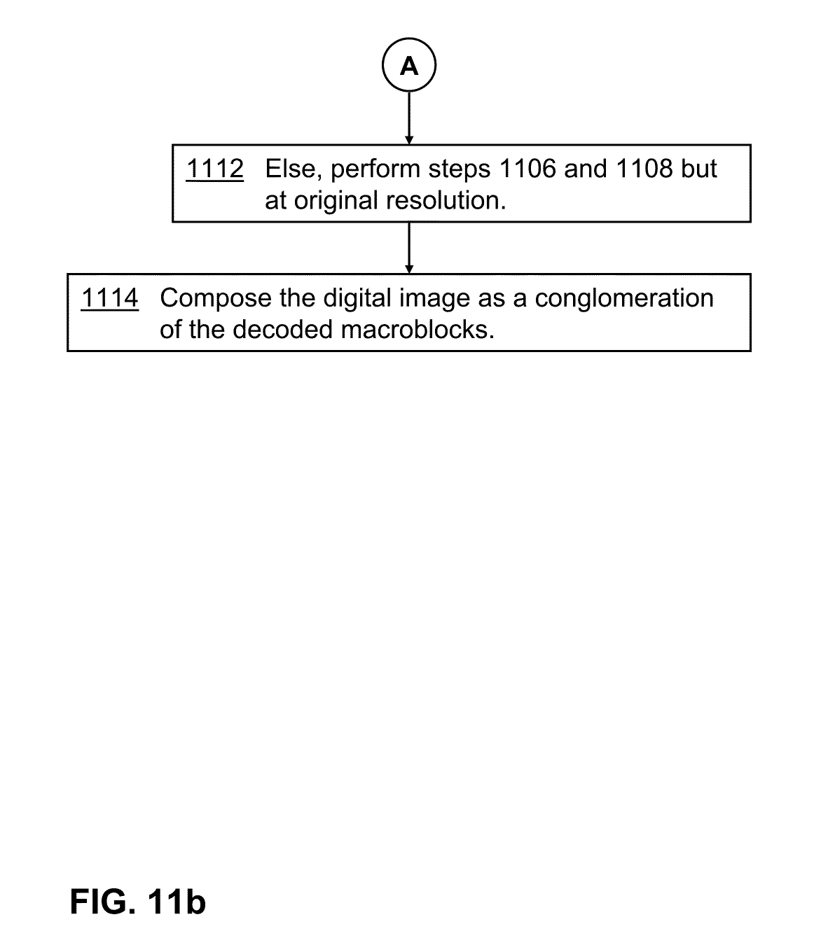

The flowchart of FIGS. 11a and 11b illustrate an exemplary RAMB decoding process. As each residual is received (steps 1100 and 1102), it is determined if the residual was encoded using RAMB. If so (step 1104), then a lower-resolution version of the macroblock is predicted (step 1106) (details here depend upon whether this is an intra or inter macroblock). The residual is used to calculate the low-resolution macroblock (step 1108). The low-resolution macroblock is then upsampled (step 1110) to obtain an original-resolution macroblock. For non-RAMB macroblocks, prior-art techniques are used in step 1112. The decoded macroblocks are formed into an image in step 1114. Thus at the decoder, RAMB can be envisioned as a normative macroblock-level tool within a hybrid-motion compensated DCT decoding paradigm.

In experiments, RAMB provides better compression efficiency than a conventional H.264/AVC encoder. This is particularly true for low bitrates. RAMB provides higher compression gains at low bitrates by using the low-resolution encoding option liberally. At these bitrates, the bits-per-pixel ratio is very low for the conventional encoder, which causes blocking artifacts, while RAMB increases the bits-per-pixel ratio by using the downsampled macroblock representation whenever there is an RD benefit. These macroblocks are usually blurry due to motion and do not contain a lot of texture; therefore, resolution rescaling does not affect them negatively, while still providing compression efficiency. Bitrate savings from these macroblocks can be used to increase the quality of other macroblocks. Hence, a quality increase at the same bitrate or bitrate savings at an equal quality as provided by H.264/AVC are possible. As the bitrate is increased, the conventional H.264/AVC codec catches up with the performance of RAMB. At high bitrates, low-resolution encoding system performance is clipped by the loss of information during the resolution scaling process, whereas at low bitrates, codec performance is dominated by the large quantization step size, which makes low resolution encoding a plausible option. At high bitrates, the RD cost of low-resolution encoding of a macroblock is typically higher than that of encoding the same macroblock in the original resolution; therefore, RAMB generally prefers to encode the macroblock in high resolution.

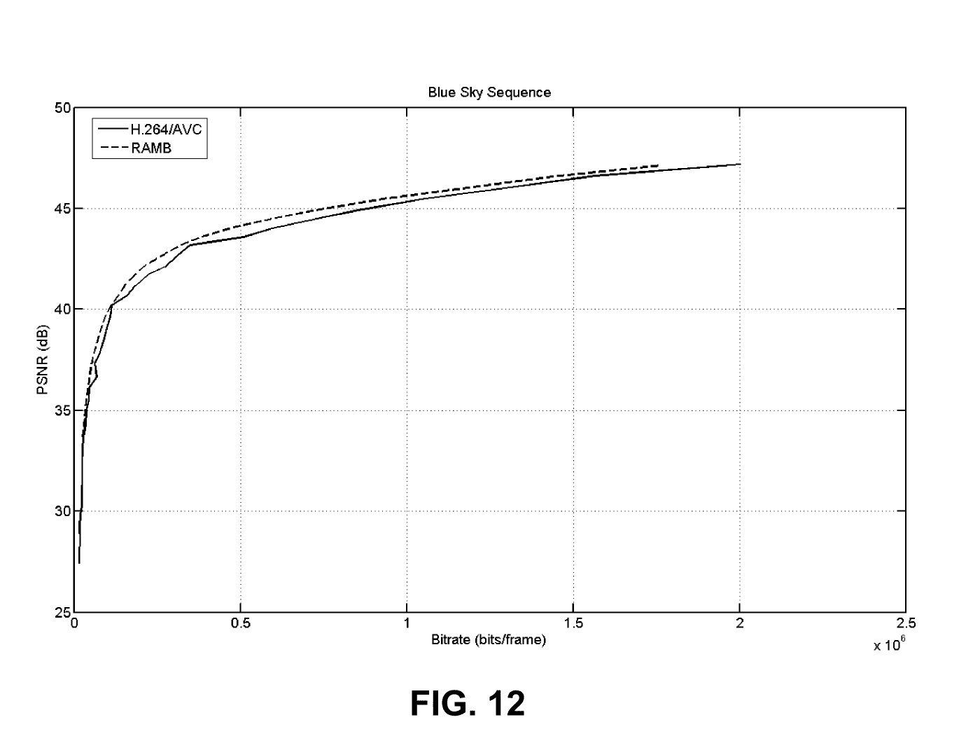

FIG. 12 shows the results of a simulation where RAMB achieves an improvement of from 0.5 to 1 dB over H.264/AVC. As expected, at higher bitrates, the ratio of macroblocks encoded in low resolution decreases, bringing RAMB's performance closer to that of H.264/AVC.

According to a second embodiment of the present invention (herein called “MAHIRVCS” for Macroblock Adaptive Hierarchical Intermediate Resolution Video Coding System), at the encoder residuals are selectively downsampled, the residual data are reorganized, and the best encoding methodology in a rate-distortion framework is chosen. On the decoder, each decoded macroblock is analyzed, the residual data are reorganized, the optimal method for upsampling the residual data is determined, and the residual data are selectively upsampled.

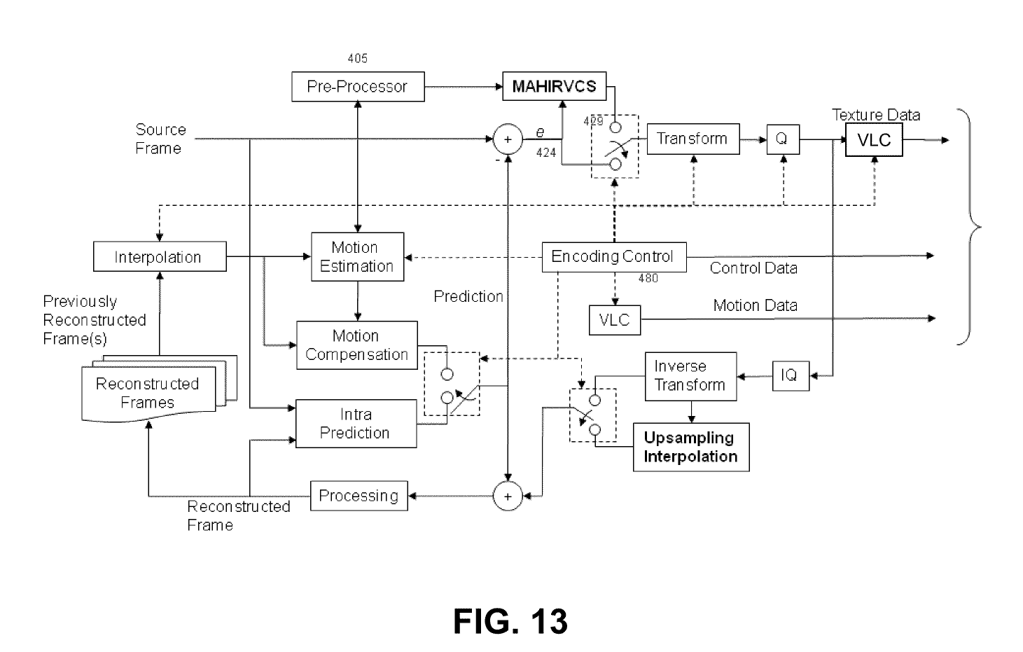

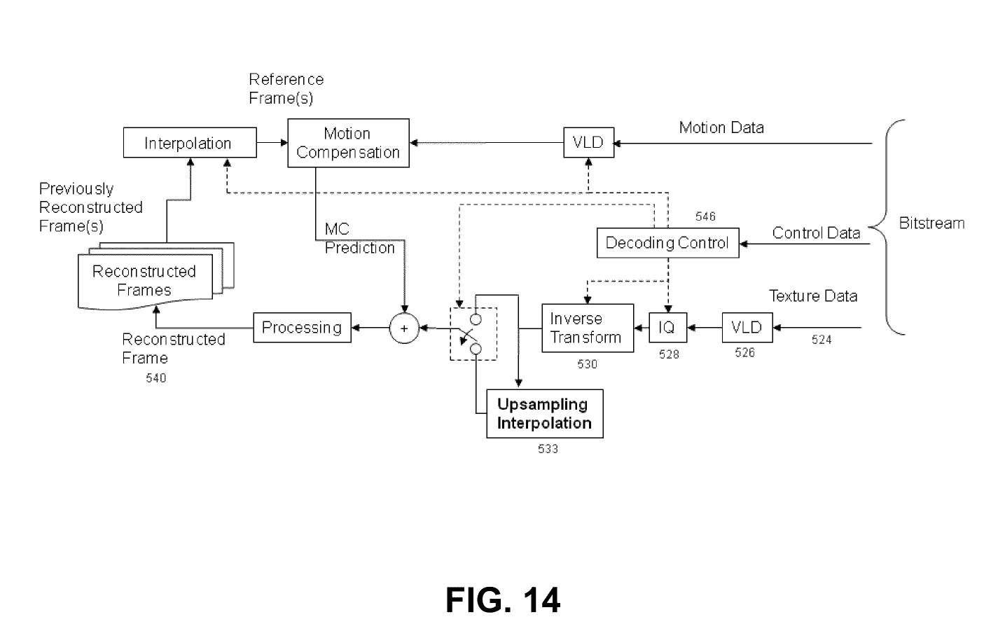

In some embodiments of MAHIRVCS, a few specific processing elements are added to the structure of an existing codec. FIG. 13 shows how MAHIRVCS-specific processing elements can be added to an existing encoder framework. (Compare FIG. 13 with the prior-art encoder of FIG. 2). Similarly, FIG. 14 shows the incorporation of MAHIRVCS-specific elements into an existing decoder. (Compare FIG. 14 with the prior-art decoder of FIG. 3).

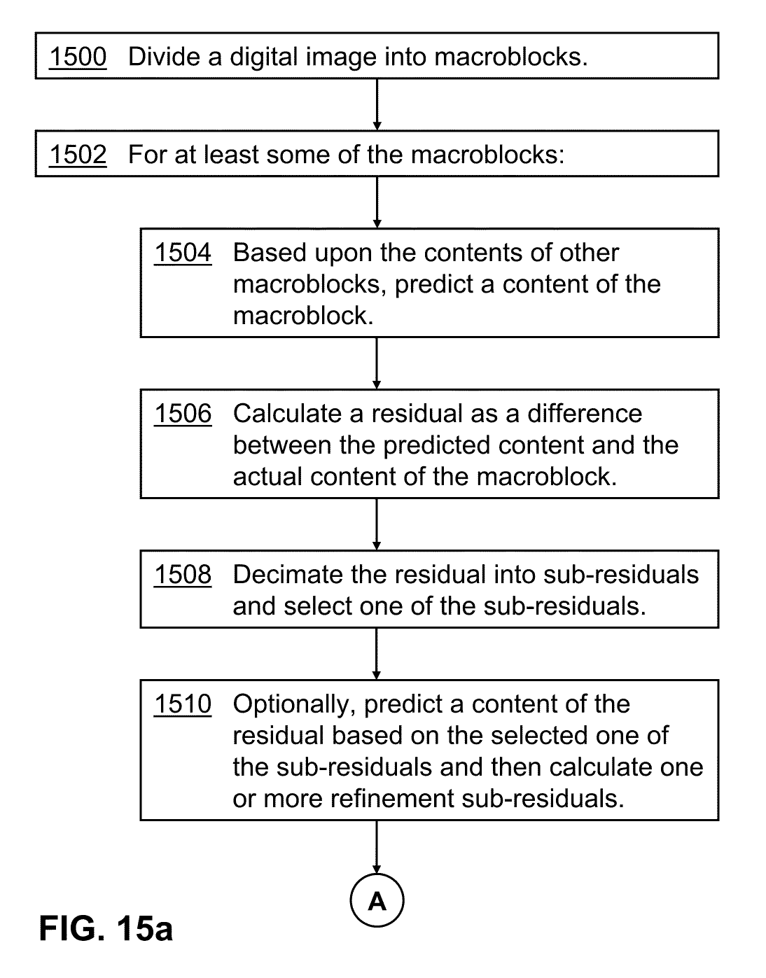

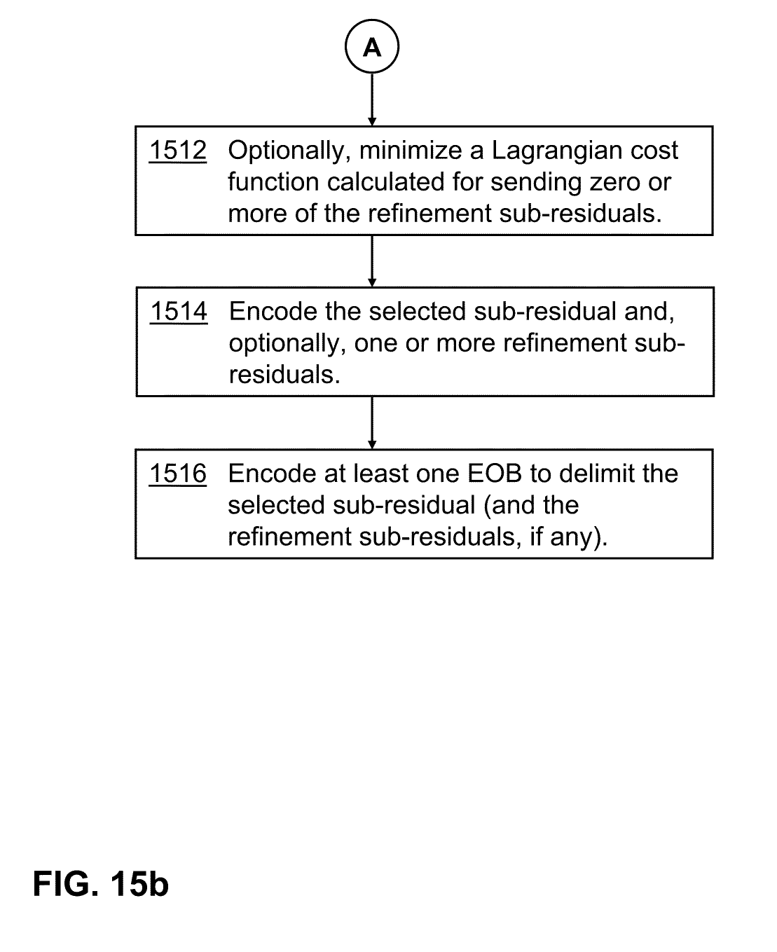

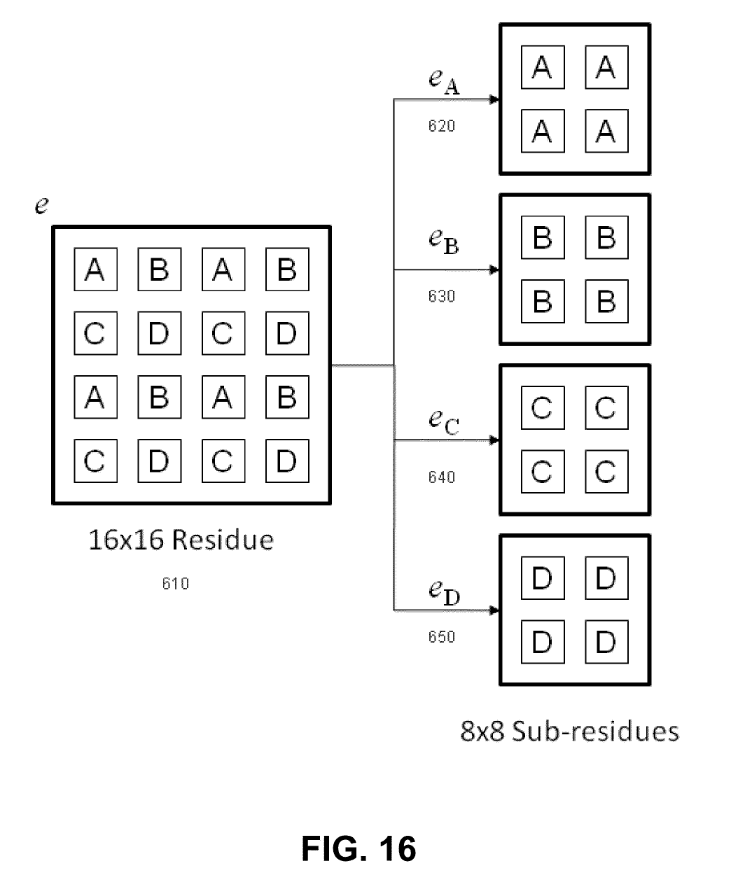

The flowchart of FIGS. 15a and 15b presents one embodiment of an MAHIRVCS encoder. The image is divided into macroblocks (step 1500 of FIG. 15a) and, for each macroblock S, the conventional H.264 intra/inter prediction procedure is executed to obtain the best prediction (step 1504). The difference between the original macroblock and its prediction, the residual e (see 610 in FIG. 16), is acquired (step 1506) and subsequently reorganized into sub-residuals e_{A}, e_{B}, e_{C}, e_{D} (620, 630, 640, and 650, respectively, in FIG. 6). This reorganization of the values is a decimation operation (step 1508). For a 16×16H.264/AVC residual, contents of the sub-residuals are:

$$\begin{matrix}\begin{matrix}\begin{matrix}{e}_{A} ( i , j ) = e ( 2 i , 2 j ) \\ {e}_{B} ( i , j ) = e ( 2 i + 1 , 2 j ) \end{matrix} \\ {e}_{C} ( i , j ) = e ( 2 i , 2 j + 1 ) \end{matrix} \\ {e}_{D} ( i , j ) = e ( 2 i + 1 , 2 j + 1 )\end{matrix} \} for i , j = 0 , 1 , … , 7 \qquad ( 11 )$$

Even though the above scheme assumes a decimation factor of two in both the horizontal and the vertical directions, an n₁xn₂ general decimation is possible.

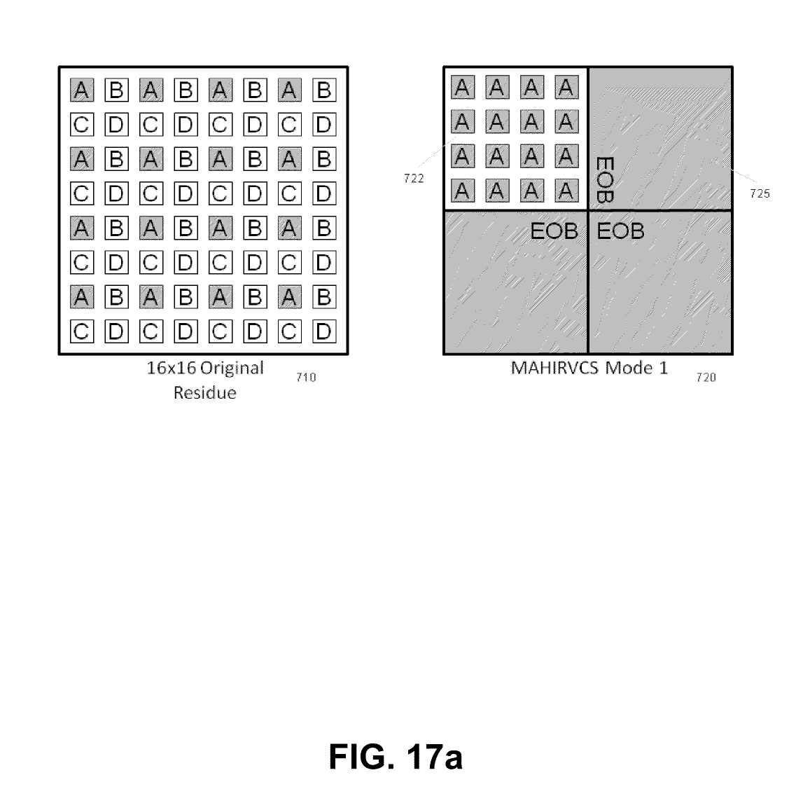

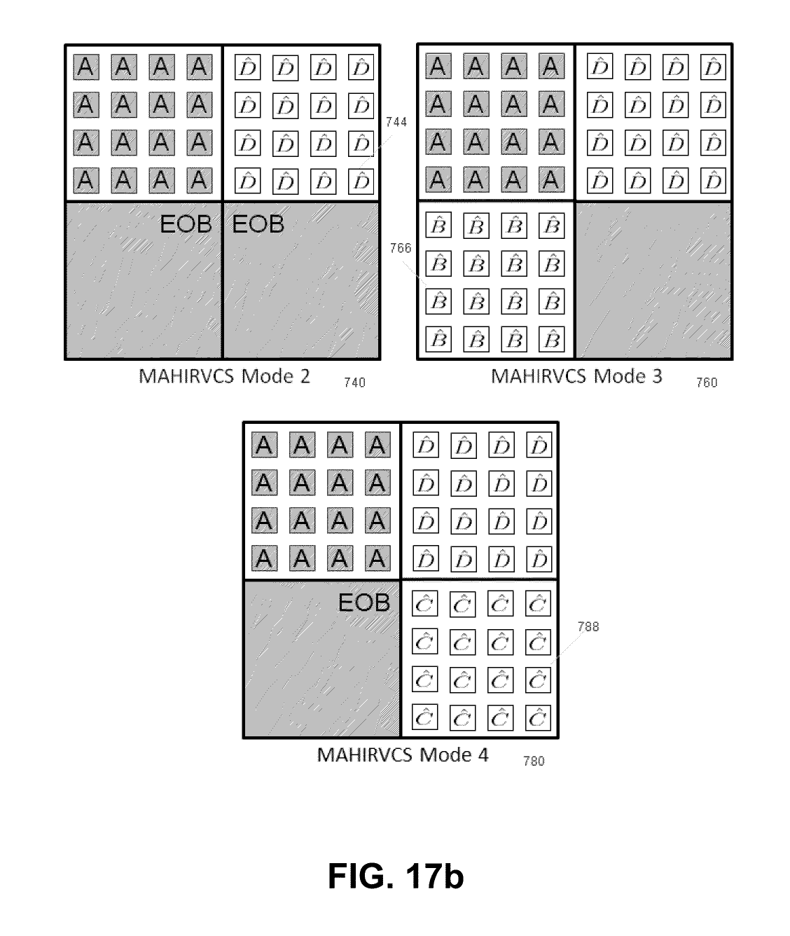

Embodiments of MAHIRVCS have the flexibility of encoding only e_{A} (MAHIRVCS Mode 1 (720 of FIG. 17a)), both e_{A} and ê_{D} (MAHIRVCS Mode 2 (740 of FIG. 17b)), e_{A} and ê_{D} and ê_{B} (MAHIRVCS Mode 3 (760)), or e_{A} and ê_{D} and ê_{C} (MAHIRVCS Mode 4 (780)). (See step 1514 of FIG. 15b.) (Of course, when the decimation is other than two-by-two, other modes are possible.) MAHIRVCS can also choose to use the original residual e (710). ê_{D}, ê_{B}, ê_{C} are called the refinement sub-residuals, and their content is explained below. Original H.264 residual coding requires the encoding of all 256 coefficients. MAHIRVCS Mode 1 encodes only e_{A} (722), which consists of 64 coefficients. For compatibility with H.264/AVC, a 16×16 residual structure is kept but end-of-block (EOB) characters (725) are signaled around the border of e_{A} to indicate that the decoder should only take the first quadrant of the received residual into account (step 1516). Similarly, if MAHIRVCS Mode 2 is selected, 128 coefficients of e_{A} and ê_{D} (744) are encoded, and if MAHIRVCS Mode 3 or Mode 4 is selected, 192 coefficients of e_{A} and ê_{D} and ê_{B} (766) or ê_{C} (788) are encoded. This operation is justified by the fact that if there is already a successful predictor for the current macroblock, a good portion of the residual data can be discarded, and the missing information can be approximated. Incremental encoding of the refinement sub-residuals has the advantage of granular quality scalability and brings finer RD optimization capability to the video coder controller.

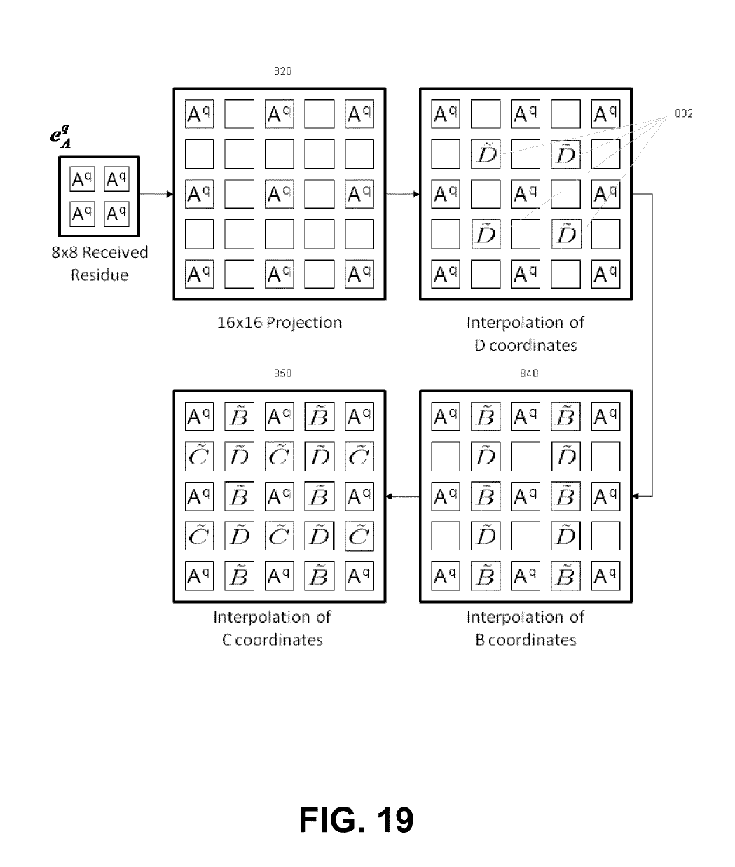

Before describing the full process of the MAHIRVCS decoder, a portion of the decoding process is here described in order to illustrate the use of sub-residuals. When reconstructing a macroblock, regular H.264/AVC intra/inter prediction is employed where the residual is added to the prediction. However, if any MAHIRVCS mode is employed in the encoding process, then the residual is upsampled before it is added. FIG. 19 shows how the received sub-residual e_{A}^{q}=T⁻¹ [symbol] Q⁻¹{Q[T(e_{A})]} [symbol] is upsampled by linear interpolation when MAHIRVCS Mode 1 is used, although more sophisticated interpolation schemes can also be employed. e_{A}^{q} is first projected onto a higher resolution grid (820) to obtain \tilde{e}:

\tilde{e}(2i,2j)=e_{A}^{q}(i,j)}i,j=0,1, . . . , 7. (12)

Values of the D-type coordinates (832) are calculated using the rounded average of the nearest four A-type neighbor values:

$$\begin{matrix}\tilde{e} ( 2 i + 1 , 2 j + 1 ) = \\ [ \begin{matrix}\begin{matrix}\tilde{e} ( 2 i , 2 j ) + \\ \tilde{e} ( 2 i + 2 , 2 j ) +\end{matrix} \\ \tilde{e} ( 2 i , 2 j + 2 ) + \\ \tilde{e} ( 2 i + 2 , 2 j + 2 ) + 2\end{matrix} ] >> 2\end{matrix} \} i , j = 0 , 1 , … , 6. \qquad ( 13 )$$

Subsequently, values of the B-(840) and C-(850) type coordinates are calculated using the rounded average of the nearest two A-type horizontal and vertical neighbor values, respectively:

\tilde{e}(2i,2j+1)=[\tilde{e}(2i,2j)+\tilde{e}(2i,2j+2)+1]>>1 for i,j=0,1, . . . , 6.

\tilde{e}(2i+1,2j)=[\tilde{e}(2i,2j)+\tilde{e}(2i+2,2j)+1]>>1 for i,j+0,1, . . . 6. (14)

The remaining border D-type coordinate values are calculated using the rounded average of the nearest two A-type neighbor values, and the remaining B- and C-type coordinate values are copied from the nearest A-type neighbor.

With the interpolation strategy described above in mind, the MAHIRVCS encoder can calculate the refinement sub-residuals ê_{D}, ê_{B}, ê_{C} which it may choose to encode along with e_{A}, in order to decrease the distortion introduced by decimation. Refinement sub-residuals are computed as:

ê_{D}(i,j)=e(2i+1,2 j+1)−\tilde{e}(2i+1,2 j+1) for i,j=0,1, . . . , 7.

ê_{B}(i,j)=e(2i+1,2j)−ê(2i+1,2j) for i,j=0,1, . . . , 7.

ê_{C}(i,j)=e(2i,2j+1)−ê(2i,2j+1) for i,j=0,1, . . . , 7. (15)

If e_{A} and ê_{D} are encoded, i.e., MAHIRVCS Mode 2 is selected, A- and D-type pixels are projected to the higher-resolution grid appropriately, and the decoder only needs to interpolate B- and C-type residual values. Similarly if MAHIRVCS Mode 3 or Mode 4 is selected, then the decoder only interpolates the missing residual values.

In step 1512 of FIG. 15b, the video encoding controller (480 of FIG. 13) determines which mode works the best for a given macroblock in an RD sense. The rates and distortions associated with encoding the residual using the three MAHIRVCS modes and the H.264/AVC residual coding are calculated. Next, a decision is made based on the Lagrangian cost function (equation 16 below) whether to directly encode the original residual (424) or one of its MAHIRVCS representations (429). More specifically, let M denote all available modes, i.e., the current conventional best mode selected prior to residual reorganization and the proposed MAHIRVCS modes. The optimal mode M* minimizes the distortion for a given sequence to a given rate constraint R_{C} as given by:

$${M}^{*} = {argmin}_{M} J ( S , M \vert λ ) \\ J ( S , M \vert λ ) = D ( S , M ) + λ R ( S , M ) \qquad ( 16 )$$

Here, D(S, M) and R(S, M) represent the total distortion and rate respectively, resulting from the selection of mode M for encoding, and λ≧0 is the Lagrangian multiplier provided by the rate controller. The video encoding controller 480 can also decide which residual encoding mode to use based on the analysis provided by the pre-processor 405. Using the pre-processor 405 can speed up the decision process and provides a side-benefit of obtaining higher-level content information such as motion and texture structure.

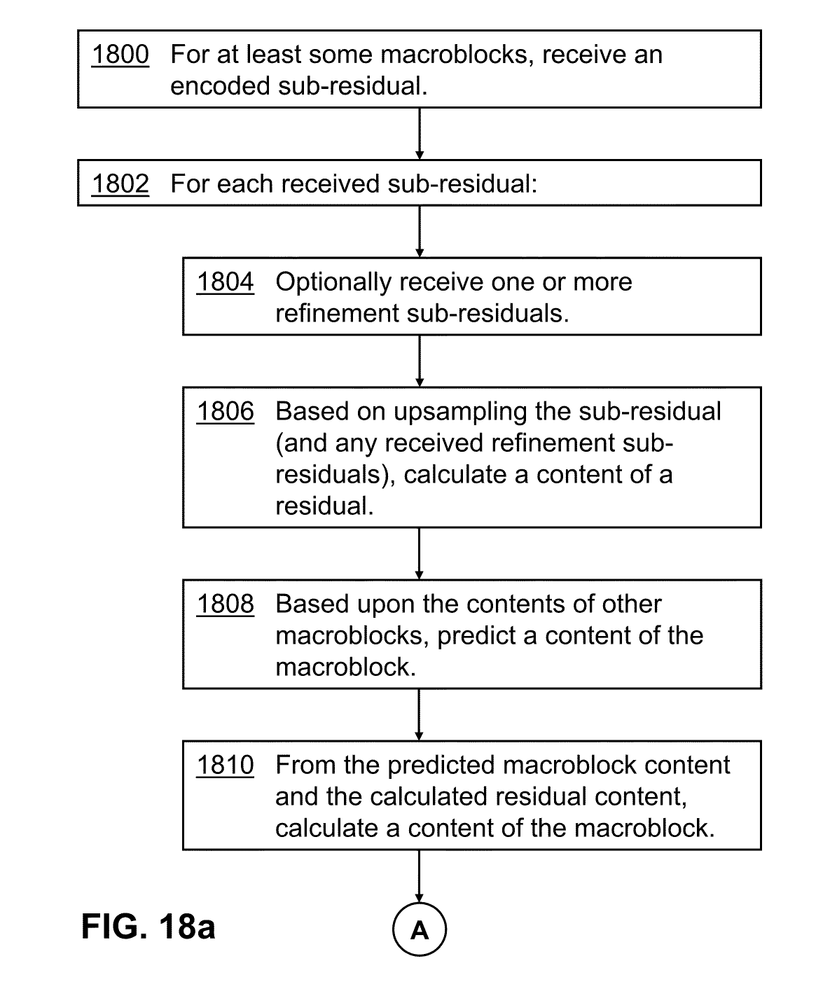

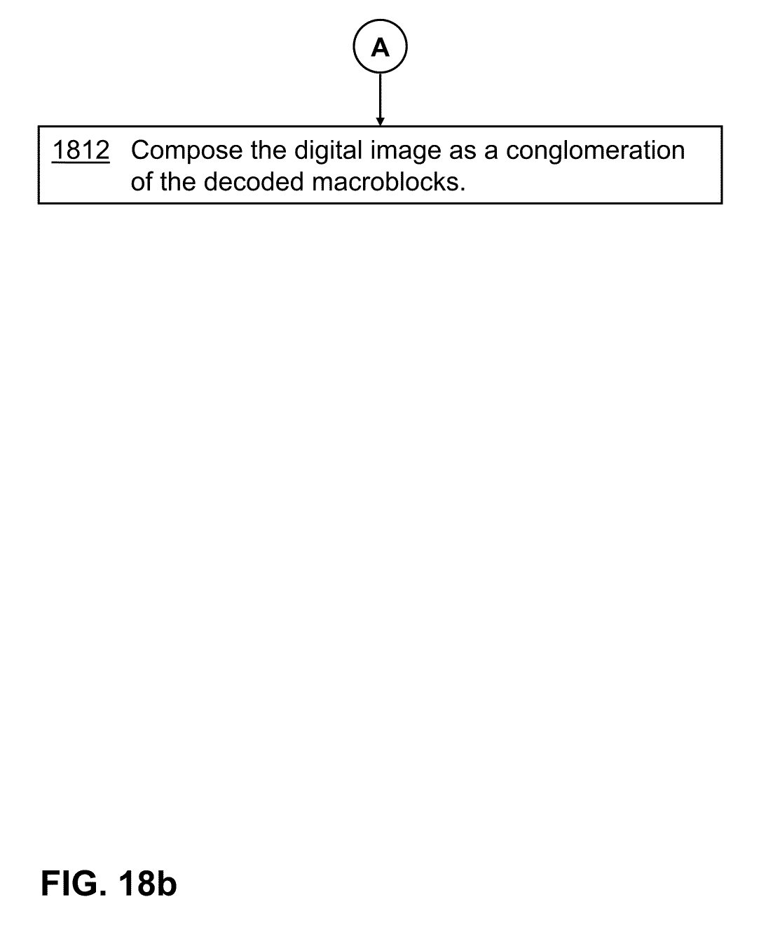

A block diagram of the MAHIRVCS-modified decoder 500 is shown in FIG. 14, and an exemplary MAHIRVCS decoding method is illustrated in the flowchart of FIGS. 18a and 18b. For each incoming macroblock, residual information (524) is decoded (526) (steps 1800, 1802, and 1804 of FIG. 18a), inverse quantized (528), and inverse transformed (530). If the use of MAHIRVCS mode is signaled by the bitstream, the decoding controller (546) turns on the Upsampling Interpolation (533). The Upsampling Interpolation projects the incoming residual information onto a higher-resolution grid (step 1806) and interpolates the missing values appropriately for the given MAHIRVCS mode (as illustrated in FIG. 19). The output of 533 is added to the intra or inter prediction (steps 1808 and 1810) to obtain the reconstructed macroblock (540). The decoded macroblocks are formed into an image in step 1812 of FIG. 18b.

Experiments show that MAHIRVCS provides compression efficiency at low-to-mid range bitrates. At low bitrates, the MAHIRVCS macroblock ratio is high, which accounts for the observed compression improvement. The ratio starts dropping as the bitrate is increased, because at high bitrates the conventional system has enough bandwidth allocated to the residual values with small step sizes. Downsampling of these residuals causes information loss which cannot be recovered with interpolation or residual refinement, making the associated RD costs of the MAHIRVCS encoding modes higher. Since the MAHIRVCS encoder decides the downsampling strategy based on the RD cost, the ratio of the low-resolution residual macroblocks also diminishes, and the MAHIRVCS coding performance merges with that of H.264/AVC.

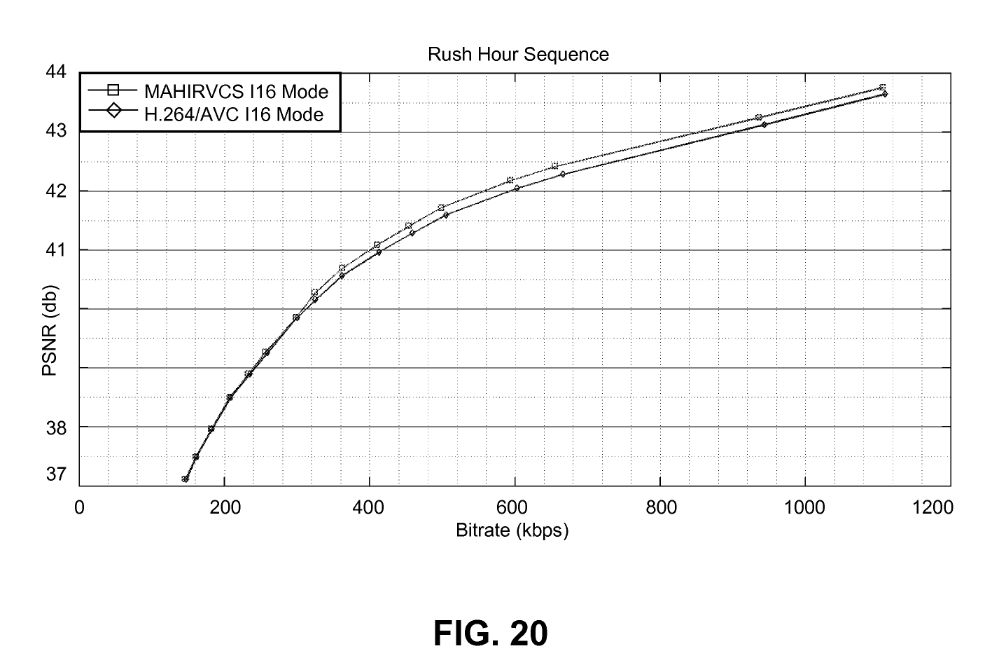

FIG. 20 shows the results of an MAHIRVCS simulation. In the “Rush Hour” sequence, at 1920×1080p, MAHIRVCS provides a 6.25% bitrate improvement at 800 Kbps with a PSNR improvement of 0.16 dB.

In view of the many possible embodiments to which the principles of the present invention may be applied, it should be recognized that the embodiments described herein with respect to the drawing figures are meant to be illustrative only and should not be taken as limiting the scope of the invention. For example, the methods of the present invention can be applied to still images as well as to video (though obviously without inter prediction), and these methods can be used with codecs other than those meeting the H.264/AVC standard. Therefore, the invention as described herein contemplates all such embodiments as may come within the scope of the following claims and equivalents thereof.

We claim:

1. A method for an image encoder to compress a digitally encoded image, the method comprising:
dividing, by the image encoder, the image into a plurality of macroblocks; and
for at least one macroblock of the plurality of macroblocks:
predicting, by the image encoder, a content of the macroblock, the predicting based, at least in part, on other macroblocks spatially near to the instant macroblock in the image or, if the image is a member of a temporal sequence of images, on macroblocks in another image previous to the instant image in the sequence;
calculating, by the image encoder, a residual as a difference between the predicted content of the macroblock and an actual content of the macroblock;
decimating, by the image encoder, the residual into a plurality of sub-residuals, wherein each sub-residual is a proper subset of the residual;
selecting, by the image encoder, one of the sub-residuals; and
sending, by the image encoder, the selected sub-residual.

2. The method of claim 1:
wherein the residual comprises a two-dimensional array of elements; and
wherein each sub-residual comprises a set of the residual elements, the elements in each sub-residual selected as residing at intersections of a starting row of the array and every subsequent Nth row of the array with a starting column of the array and every subsequent Mth column of the array, for N and M integers greater than one.

3. The method of claim 2 wherein, for the selected sub-residual, the starting row is a topmost row of the array and the starting column is a leftmost column of the array.

4. The method of claim 1 further comprising:
for the at least one macroblock of the plurality of macroblocks:
sending, by the image encoder, at least one EOB to delimit the selected sub-residual.

5. The method of claim 1 further comprising:
for the at least one macroblock of the plurality of macroblocks:
predicting, by the image encoder, a content of the residual, the predicting based, at least in part, on the selected sub-residual; and
for at least one sub-residual other than the selected sub-residual, calculating, by the image encoder, a refinement sub-residual, the calculating based, at least in part, on a difference between the predicted content of the residual and an actual content of the residual.

6. The method of claim 5 further comprising:
for the at least one macroblock of the plurality of macroblocks:
sending, by the image encoder, at least one refinement sub-residual.

7. The method of claim 5:
wherein the residual is represented by the selected sub-residual and N refinement sub-residuals, for N an integer greater than one;
the method further comprising:
for the at least one macroblock of the plurality of macroblocks:
deciding, by the image encoder, how many refinement sub-residuals of the decimated residual to send, wherein the deciding is based, at least in part, on minimizing a Lagrangian cost function taken over rates and distortions calculated for sending each of from 0 through N−1 refinement sub-residuals; and
sending, by the image encoder, the decided number of refinement sub-residuals.

8. A method for an image decoder to decompress a digitally encoded image from a plurality of macroblocks, the method comprising:
for at least one macroblock of the plurality of macroblocks:
receiving, by the image decoder, a sub-residual of the macroblock;
calculating, by the image decoder, a content of a residual of the macroblock, the calculating based, at least in part, on upsampling the received sub-residual;
predicting, by the image decoder, a content of the macroblock, the predicting based, at least in part, on other macroblocks spatially near to the instant macroblock in the image or, if the image is a member of a temporal sequence of images, on macroblocks in another image previous to the instant image in the sequence; and
calculating, by the image decoder, a content of the macroblock, the calculating based, at least in part, on the calculated residual and on the predicted content of the macroblock; and
composing, by the image decoder, the digitally encoded image as a conglomeration of the plurality of macroblocks.

9. The method of claim 8:
wherein the residual comprises a two-dimensional array of elements; and
wherein the received sub-residual comprises a set of the residual elements, the elements in the received sub-residual selected as residing at intersections of a starting row of the array and every subsequent Nth row of the array with a starting column of the array and every subsequent Mth column of the array, for N and M integers greater than one.

10. The method of claim 9 wherein, for the received sub-residual, the starting row is a topmost row of the array and the starting column is a leftmost column of the array.

11. The method of claim 8 wherein calculating the content of the residual is based, at least in part, on a method selected from the group consisting of: a linear interpolation and a geometric spline.

12. The method of claim 8 further comprising:
for the at least one macroblock of the plurality of macroblocks:
receiving, by the image decoder, at least one EOB to delimit the received sub-residual.

13. The method of claim 8 further comprising:
for the at least one macroblock of the plurality of macroblocks:
receiving, by the image decoder, at least one refinement sub-residual;
wherein calculating the content of the residual of the macroblock, is based, at least in part, on the received refinement sub-residual.

14. An image encoder for compressing a digitally encoded image, the image encoder comprising:
a communications interface configured for receiving the image; and
a processor configured for:
dividing the image into a plurality of macroblocks; and
for at least one macroblock of the plurality of macroblocks:
predicting a content of the macroblock, the predicting based, at least in part, on other macroblocks spatially near to the instant macroblock in the image or, if the image is a member of a temporal sequence of images, on macroblocks in another image previous to the instant image in the sequence;
calculating a residual as a difference between the predicted content of the macroblock and an actual content of the macroblock;
decimating the residual into a plurality of sub-residuals, wherein each sub-residual is a proper subset of the residual;
selecting one of the sub-residuals; and
sending, via the communications interface, the selected sub-residual.

15. The image encoder of claim 14:
wherein the residual comprises a two-dimensional array of elements; and
wherein each sub-residual comprises a set of the residual elements, the elements in each sub-residual selected as residing at intersections of a starting row of the array and every subsequent Nth row of the array with a starting column of the array and every subsequent Mth column of the array, for N and M integers greater than one.

16. The image encoder of claim 15 wherein, for the selected sub-residual, the starting row is a topmost row of the array and the starting column is a leftmost column of the array.

17. The image encoder of claim 14 wherein the processor is further configured for:
for the at least one macroblock of the plurality of macroblocks:
predicting a content of the residual, the predicting based, at least in part, on the selected sub-residual; and
for at least one sub-residual other than the selected sub-residual, calculating a refinement sub-residual, the calculating based, at least in part, on a difference between the predicted content of the residual and an actual content of the residual.

18. The image encoder of claim 17 wherein the processor is further configured for:
for the at least one macroblock of the plurality of macroblocks:
sending, via the communications interface, at least one refinement sub-residual.

19. The image encoder of claim 17:
wherein the residual is represented by the selected sub-residual and N refinement sub-residuals, for N an integer greater than one; and
wherein the processor is further configured for:
for the at least one macroblock of the plurality of macroblocks:
deciding how many refinement sub-residuals of the decimated residual to send, wherein the deciding is based, at least in part, on minimizing a Lagrangian cost function taken over rates and distortions calculated for sending each of from 0 through N−1 refinement sub-residuals; and
sending, via the communications interface, the decided number of refinement sub-residuals.

20. An image decoder for decompressing a digitally encoded image from a plurality of macroblocks, the image decoder comprising:
a communications interface; and
a processor configured for:
for at least one macroblock of the plurality of macroblocks:
receiving, via the communications interface, a sub-residual of the macroblock;
calculating a content of a residual of the macroblock, the calculating based, at least in part, on upsampling the received sub-residual;
predicting a content of the macroblock, the predicting based, at least in part, on other macroblocks spatially near to the instant macroblock in the image or, if the image is a member of a temporal sequence of images, on macroblocks in another image previous to the instant image in the sequence; and
calculating a content of the macroblock, the calculating based, at least in part, on the calculated residual and on the predicted content of the macroblock; and
composing the digitally encoded image as a conglomeration of the plurality of macroblocks.
